(19) United States
(12) Patent Application Publication
(10) Pub. No.: US 2007/0300179 A1
(43) Pub. Date: Dec. 27, 2007

(54) User-application interaction recording

(75) Inventor: Gabriel Friedlander, Tel Aviv (IL)

Correspondence Address: EMPK & SHILOH, LLP, 116 John St., Suite 1201, New York, NY, 10038, US

(73) Assignee: Observe IT Ltd., Ramat Gan (IL)

(21) Appl. No.: 11/475,550

(22) Filed: Jun. 27, 2006

(51) Int. Cl. G06F 3/048

(52) U.S. Cl. 715/781

(57) ABSTRACT

A method for recording user/application interaction is provided. The method may include intercepting, by a user/application monitoring agent, an application window running on a computer and currently being visited by a user, and generating a unique window identifier for said application window based on one or more structural elements of said application window Structural elements may include, for example, label(s), drop-down list(s), drop-down menu(s), text(s), option box(es), and/or checkbox(es). The unique window identifier may be a hash value that is obtained by hashing structural elements of the related application window. Unique window identifier(s) may be utilized in visual audit trail, troubleshooting, guidance, help or assistance associated with a running application, which may be rendered to a user based on the current user's relative location within the application visited by him/her. Screenshots may be played to a user, upon the user's demand, as video clip(s) or screenshots slides, by using window identifiers to respectively retrieve stored screenshots A monitoring agent is also provided, which utilizes the method.

### FIELD OF THE DISCLOSURE

The present disclosure generally relates to the field of computers More specifically, the present disclosure relates to a method and system for recording and utilizing user(s)-application(s) interactions.

### BACKGROUND

Not many will disagree that we are living in the ‘computer era’, and that the computer is here to stay because computers play a major role in many aspects of human activities For example, computers have been used for entertainment as well as for facilitating and promoting scientific researches A typical computer infrastructure includes several computers connected (over a network) to common computer(s) generally called a ‘server’

In information technology, a server is a computer system that provides services to other computing systems—generally called clients—over a network The term ‘server’ is most commonly applied to a complete computer system today, but it is also used occasionally to refer only to the hardware or software portions of such a system In general, a ‘client’ is a computer system that accesses a (remote) service on another computer (usually a server) over some kind of network. ‘Client-Server’ refers to a network architecture which separates the client (often a graphical user interface (GUI)) from the server. The client software can send, at each instance, requests to a server or application server that is a server computer in a computer network dedicated to running certain software applications. The term ‘application server’ also refers to the software installed on such a computer to facilitate the serving (running) of other applications

Servers have come into being in parallel with computer networks. Networks allow computers to communicate with each other, and an outgrowth of this was the tendency to dedicate some computers to a serving role while other computers (those that interact directly with human users) assume a client role. Server computers and their associated software evolved to fill the server role As networks have grown and developed, so have servers.

### Server Applications

Server applications are tailored to the tasks performed by servers, just as desktop or mainframe applications are tailored to their own respective environments Most server applications are distinguished by the fact that they are completely non-interactive on the local server itself; that is, they do not display information on a screen and do not expect user input. Instead, they run unobtrusively within the server and interact only with client computers on the network to which the server is attached Applications of this kind ale called daemons in UNIX terminology, and services in Windows terminology

Server applications are typically started once when the server is booted, and thereafter run continuously until the server is stopped. A given server usually runs the same set of applications at all times, since there is no way for the server to predict when a given service might be requested by a client computer. Some server applications in some server systems are automatically started when a request from a client is received and stopped when the request has been satisfied.

### Server Software

The major difference between servers and desktop computers is in the software Servers often run operating systems that are designed specifically for use in servers. They also run special applications that are designed specifically to carry out server jobs or tasks A typical server is a computer system that operates continuously on a network and waits for requests for services from other computers on the network Many servers are dedicated to this role, but some may also be used simultaneously for other purposes, particularly when the demands placed upon them as servers are modest. For example, in a small office, a large desktop computer may act as both a desktop workstation for one person in the office and as a server for all the other computers in the office Servers frequently host hardware resources that they make available on a controlled and shared basis to client computers, such as printers and file systems. This sharing permits better access control and can reduce costs by reducing duplication of hardware.

As opposed to servers, mainframes are very large computers that centralize certain information-processing activities in large organizations and may or may not act as servers in addition to their other activities Many large organizations have both mainframes and servers, although servers usually are smaller and much more numerous and decentralized than mainframes.

Sometimes, a network administrator or an organization manager may wish to monitor activities on all (or on selected) client computers in his organization, including those in which client-application and server-client interactions are/were involved A well designed computer-wise activities monitoring methodolgy will be able to tell the organization management, or the computer system's adminstrator, whether wanted working standards and expected computer-wise behavior are being maintained by the organization employees.

For example, an organization manager may wish to know which one of his employees changed any of the settings of a particular computer application, or what was the chain of events that preceeded a certain application's collapse An organization manager may also wish to keep track of every unusual computer-wise activity of his employees An organization manager may also wish to know, for example, who activated a certain application and what data s/he have entered to, or retrieved from, a database associated with that application Further, since, typically, software and hardware elements are arranged in heirarchical manner, an organization manager or the network administrator may also wish to now the location of a given user/client in the computer system. Questions like “Who changed the application's configuration ?” or “Who unchecked a certain checkbox ?” are typical questions a computer system adminstrator may wish to get answers for

Several solutions for partially coping with this and with other types of questions exist. For example, Intellinx disclosed end-user behavior tracking solution for safeguarding against an insider threat In general, the Intellinx solution allows a large organization to fight against deliberate deceptions from legitimate end-users that were granted an access to the organization's business applications.

For that purpose, Intellinx's solution involves tapping the network data traffic and recording all the activities of every end-user in every business application in heterogeneous environments across the enterprize or organization, including mainframe, iSeries, client-server, web and so on The Intellinx's solution allows an auditor to replay end-users activities screen-by-screen and keystroke-by-keystroke (using an audit trail), as if the auditor was looking over each end-user shoulder The Intellinx's solution utilizes a rule engine capable of tracking users' behavior patterns in real-time and triggering instant alerts on irregularities, whereby to allow the security officer to immediately zoom-in on specific suspect and replay all his/her actions or activities related to suspicious event(s) The Intellinx's rule engine is designed to generate a detaild forensic audit trail of user access to the corporate application and data enabling the organization to comply with government regulations, including GLBA (Gramm-Leach-Bliley Act), HIPP (Health Insurance Portability and Accountability Act), Sarbanes-Oxley and Basel 2

However, Intellinx's solution has several drawbacks For example, the Intellinx's solution (which is generally categorized as internal fraud application and it is amid as fraud detection software aimed at intercepting employees' abnormal (usually finance-wise) transactions) is based on sniffing network traffic Therefore, the Intellinx's solution is application-dependent, or application-targeted, because sniffing a network traffic requires that the Intellinx's solution be tailored to specific communication protocols, usually used by a mainframe system and International Business Machines (IBM's) AS/400 (Application System/400, also known as iSeries (since 2000) and System i5 (since 2006)) In addition, due to its nature, the Intellinx's solution is limited to monitoring only several communication protocols (among them are IBM 3270 and IBM 5250), by using the Transmission Control Protocol Internet Protocol (TCP/IP) or Systems Network Architecture (SNA) communication standards.

Further, the Intellinx's solution has to be adjusted for every application that is wished to be monitored, and in addition, because of the sniffing nature of the Intellinx's solution (tapping data that travels through the network) it cannot be used to monitor the activity done on a server-client system that is not travels through the network; that is, there are cases where activity occurs on a client computer with no data being forwarded or received (from/at the client computer) over the network, for which reason such activity cannot be monitored (sniffed), or tracked down, using the Intellinx's solution

Further, the Intellinx's solution does not generate an identification data for application window(s) or portlet(s) viewed/visited by a user. Therefore, the Intellinx's solution does not have location-based functionality; that is, Intellinx cannot perform location-based searching which is based on the unique identification of application windows (s) or portlet(s)). In addition, the Intellinx's solution cannot share or push information, according to needs, based on the location of client(s) Further, the Intellinx's solution is not self-learning in the sense that if certain user steps caused a problem, no traces of these steps will be kept in the system that will inform, help or assist other users in similar situations

Another solution called “AppSight” (from a company called Identity) allows monitoring application(s) executions and capturing, communicating and determining the root cause of application(s) problems. AppSight accelerates problem resolution processes during the application's lifcycle. AppSight is a system built upon a unique problem resolution architecture that was designed to optimize the problem resolution process. It is intended to be used by large-scale enterprises, ISVs (Independent Software Vendors) and IT (Information Technology) Solution Providers to speed application delivery, increase application quality, performance and availbility, and reduce application support costs

AppSight is generally categorized as a problem resolution application It is amid to be used by expert technicians (support team, developers, and so on) in order to understand the root cause of application problems Because of the huge amount and complexity of information usually associated with computers' activities, AppSight records information (screen snapshots, system information, log files and code execution) only when software problems occur. Usually, recording the information is preconfigured by the computer user.

AppSight has several drawbacks For example, AppSight is only activated by a user-defined alerting mechanism and, because AppSight is primarily designed to assist in handling a software malfunction, AppSight is designed to capture data associated with such malfunctions. That is, although AppSight may monitor essentially every activity, it records only data related to a malfunctioning software, as is predefined by the user. In addition, when AppSight starts recording, it records essentially anything, which means that: (1) a large memory space will be likely consumed, and (2) a lot of irrelevant data will be likely stored in the system, which may generally degrade the overall performance of the system using AppSight In addition, AppSight is application-dependent and it is limited to Microsoft Windows, Net Framework and J2EE, a Java Platform (Enterprise Edition or Java EE, formerly known as Java 2 Platform, Enterprise Edition or J2EE up to version 1.4) that is a programming platform (part of the Java platform) for developing and running distributed multi-tier architecture Java applications that is based largely on modular software components running on an application server. Further, AppSight does not does not have location-based functionality; that is, AppSight does not generate an identification data for application window(s) or portlet(s) viewed/visited by a user. Therefore, AppSight cannot perform location-based searching which is based on the unique identification of application window(s) or portlet(s)). In addition, AppSight cannot share or push information, according to needs, based on the location of client(s). Further, AppSight is not self-learning in the sense that if certain user steps caused a problem, no traces of these steps will be kept in the system that will inform, help or assist other users in similar situations

Spector CNE, a computer and Internet monitoring software, is designed to provide businesses with a presumably complete and relatively accurate record of all their employees' PC and Internet activity Spector CNE is aimed at preventing, reducing or eliminating problems associated with Internet and PCs abuse For example, Spector CNE allows an organization manager to know what exactly his employees are doing on the Internet. Spector CNE also allows a system manager to install, configure, record and review Internet and PC activities across the system's network For example, Spector CNE may be configured to record every e-mail sent and received, as well as chat conversations and instant message (types of Internet services), every website visited by an employee, every keystroke, every application launched, and detailed pictures of PC activity in the form of periodic screen snapshots In general, Spector CNE is categorized as a Spyware, or surveilance, application that monitors computer activities of employees

However, Spector CNE has several drawbacks. For example, Spector CNE records screen snapshots according to a predefined interval that is set by a user (often the system adminstrator). Therefore, and depending on the predefined recording interval, many (for example hundereds of) snapshots (and related data, for example metadata) may be recorded during each hour and for each computer, many of which may be identical, or similar, to some of the previously (already) recorded snapshots and related data. Identical, or similar, snapshots consume memory space, though they may bear a little information, if at all.

A typical scenario which demonstrates that problem is when a PC user reads an article without changing anything on his computer's screen but identical (duplicate) snapshots of the (unchanging) screen are continuously recorded according to the specified recording interval Another typical scenario is when a PC user moves (whether accidentally or delibrately) the computer mouse without trigerring any activity or activating any application. In such scenarios, consecutive snapshots may be recorded, though the mere movements of the computer's mouse (which will be noticed or reconstracted using the snapshots) may be meaningless. Since Spector CNE records snapshots according to a predefined recording interval, activities of high importance, which may occur in between two consecutive recordings will, therefore, be missed or overlooked, for not being recorded.

Because of the latter described drawback, the choice of recording snapshots is often taken selectively, in the sense that screen snapshots are usually recorded only when a real need arises, such as when computer-wise activities are suspected as deviating from the organization's norm or standards and there is, therefore, a need to track down future activities which will be done on or through the suspected computer(s)

Another drawback of Spector CNE is that Spector CNE detects computer-wise activities within applications windows without associating the activities to a particular server, computer or user. Therefore, if an action was maliciously, naively or accidentally taken in regard of a particular application, no computer or server will be associated with this action. Further, Spector CNE does not does not have location-based functionality; that is, Spector CNE does not generate an identification data for application window(s) or portlet(s) viewed/visited by a user. Therefore, Spector CNE cannot perform location-based searching which is based on the unique identification of application window(s) or portlet(s)) In addition, Spector CNE cannot share or push information, according to needs, based on the location of client(s) Further, Spector CNE is not self-learning in the sense that if certain user steps caused a problem, no traces of these steps will be kept in the system that will inform, help or assist other users in similar situations

### Glossary

### Computer Data Logging

In computerized data logging, a computer program may automatically record events (for example user activity steps, or user-application interaction) in a certain scope in order to provide an audit trail that can be used, for example, to diagnose problems In many cases, logs are esoteric and hard to understand; they need to be subjected to log analysis in order to make sense of them server log is a file (or several files) automatically created and maintained by a server of activity performed by it Data logging is the practice of recording sequential data, often chronologically.

### Audit Trail

An audit trail is a chronological sequence of audit records, each of which may contain evidence directly pertaining to and resulting from the execution of a business process or system function Audit records typically result from activities such as user-computer transactions or communications by individual people, systems or other entities An audit trail may also be thought of as a record showing who (in an organization) has accessed a computer system and what operations s/he has performed during a given period of time

### Information Technology

Information Technology (IT) or Information and Communication(s) Technology (ICT) is a broad subject concerned with technology and other aspects of managing and processing information, especially in large organizations In particular, IT deals with the use of electronic computers and computer software to convert, store, protect, process, transmit, and retrieve information

### International Business Machines (IBM)

An IBM mainframe is a large, high performance computer made by IBM. Mainframe computers traditionally are expensive, individually physically large and have high transaction processing and input-output (I/O) performance. Mainframes are large and expensive computers used mainly by government institutions and large companies for mission-critical applications The IBM 3270 is a class of terminals made by IBM (known as “Display Devices”) and normally used to communicate with IBM mainframes Use of 3270 is slowly diminishing over time as more and more mainframe applications acquire Web interfaces, but in some situations (such as call centers) the “green screen” 3270 interface is still the most productive and efficient IBM 5250, originally, was a particular model of a terminal device sold with the IBM S/34 minicomputer system Similar to the IBM 3270, it is a block-oriented terminal protocol, yet is incompatible with the 3270 standard

### Systems Network Architecture (SNA)

SNA is an IBM's proprietary networking architecture created in 1974 It is a complete protocol stack for interconnecting computers and their resources SNA describes the protocol and is, in itself, not actually a program. SNA is still used extensively in banks and other financial transaction networks, as well as in many government agencies.

### Screenshot, Screen Dump, or Screen Capture or Screenie

A screenshot is an image taken by the computer to record the visible items on the monitor or another visual output device Usually, this is a digital image taken by the host operating system or software running on the computer device. A screenshot generally refers to outputting the entire screen content in a common format such as PNG (Portable Network Graphics) or JPEG (Joint Photographic Experts Group). A screen capture involves capturing the screen over an extended period of time to form a video file Screenshots, screen dumps, or screen captures can be used to demonstrate a program, a particular problem a user might be having or, generally, when computer output needs to be shown to others or archived.

### Hash Function

A hash function (or bash algorithm) is a way of creating a small digital “fingerprint” from any kind of data. The function chops and mixes the data to create the fingerprint, often called a hash value. The hash value is commonly represented as a short string of random-looking letters and/or numbers.

### Unique Window Identifeir

A unique window identifier is generally an alphanumeric ‘fingerprint’ that uniquely characterizes a foreground application window or portlet by referring to the combination of structural elements of the application window/portlet Exemplary tructural elements may be label(s), text box(es), pop-down list(s), checkbox(es) and additional/other like element(s) and/or object(s). The alphanumeric-like fingerprint may be, for example, a hash value that is derived from structural elements of the application window/portlet Wherever the term ‘application window’ is used hereinafter it should be construed as referring to an application window or to an application portlet, which ever the case may be. In computer science a foreground application window/portlet is a window for an active application

### Location of a User

‘Location’ generally means herein the whereabouts of a user within a computer system that may run or use multiple applications. A user's location may be found by associating a unique window identifier with an application window visited by the user. If more than one window simultaneously appear on a computer monitor (for example in a ‘window-in-window’ manner), the location of the user will be determined, as a general rule, according to the window/portlet currently ‘highlighted’ (currently active or waiting for user's interaction(s)) In many cases, the application window that is currently active or waiting for user's interaction(s) is the foreground application window.

### SUMMARY

The following embodiments and aspects thereof are described and illustrated in conjunction with systems, tools and methods, which are meant to be exemplary and illustrative, not limiting in scope In various embodiments, one or more of the above-described problems have been reduced or eliminated, while other embodiments are directed to other advantageous or improvements.

In one embodiment, there is provided a user/application monitoring agent adapted to characterize an application window running on a computer and generate a unique window identifier for the application window based on one or more structural elements of said application window

In another embodiment there is provided a system for application and application windows characterization, including a processor, computer or server, and an application characterization module or agent adapted to scan structural elements within an application window, which may be (though this is not necessarily so) the foreground window, and to designate an identifier with structural element(s) within the (foreground) application window.

According to some embodiments, the system may also include a search engine adapted to perform a search which may locate other application windows which have essentially the same unique window identifier as a certain window application, such as a window application being visited by the user. The search results, all of which have essentially the same unique window identifier, may be related to different user activity steps, different sessions and/or different users. The search engine may locate the user's current location and may provide previously recorded information and/or video stream and/or screenshots slides relevant to, associated with, based on or derived from the same unique window identifier of the application window/screen for which the user has initiated the search process The search engine displays a list of essentially all video clips which may include screenshot(s) associated with application(s) window(s) whose unique window identifier(s) is essentially identical to the unique window identifier of the application window being currently visited.

According to some embodiments, the user/application monitoring agent may visually attach to a foreground application window a “guiding note” (may also be referred to as a “sticky note”) associated with said application window or with the application involved. The guiding note may pass or share information to or with user(s) Such information may be for example best practice(s), or instructions/recommendations on selecting (or deferring) specific options in the application window. The guiding note may be respectively associated with a unique window identifier The guiding note may be presented every time the specific application window is activated, for example, from a computer or server, by a user or client regardless to the computer or server which the guiding note was created. In one embodiment, every time the application window is activated a unique window identifier is generated, for example by the monitoring agent or the central server and is compared against previously stored “Sticky Note(s)” on the central server or monitoring agent. If there is a match between the unique window identifiers of the current application window and one or more unique window identifiers associated with previously stored Sticky Note(s), the corresponding matching sticky note(s) may be presented to the user/client

In another embodiment, there is provided a method of computer application characterization, including scanning structural elements within a foreground application window; and designating an identifier with structural element(s).

As part of the present disclosure a method for recording user/application interaction is provided. The method may include intercepting, by a user/application monitoring agent, a foreground application window running on a computer and currently being visited by a user, and generating a unique window identifier for the application window based on one or more structural elements of the application window Structural elements may include: label(s), drop-down lists, drop-down menus, text, option boxes, checkboxes, combo box(es), list box(es), image(s) and button(s).

The unique window identifier may be a hash value that is obtained by hashing data representing structural elements of the related application window. Unique window identifier(s) may be utilized in visual audit trail, troubleshooting, guidance, help or assistance associated with a running application, which may be tendered to a user based on the current user's relative location within the application visited by him/her.

Screenshots of application windows respectively associated with unique window identifiers may be recorded and later played to a user, upon the user's demand, as video clip(s) or screenshots slides, by using window identifiers to respectively retrieve stored screenshots A monitoring agent is also provided, which utilizes the method.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures It is intended that the embodiments and figures disclosed herein be considered illustrative, rather than restrictive The disclosure, however, both as to organization and method of operation, together with objects, features, and advantages thereof, may best be understood by reference to the following detailed description when read with the accompanying figures, in which:

FIG. 1 schematically illustrates a user-application recording system according to an embodiment of the present disclosure;

FIG. 2a shows an exemplary high-level flowchart for recording unique window identifiers for application window(s) visited by user(s) according to some embodiments of the present disclosure;

FIG. 2b shows an exemplary general flowchart for retrieving information by user(s) based on a user location within an application;

FIG. 3 depicts two exemplary application windows/portlets for demonstrating how a unique window identifier may be generated for an active application window/portlet;

FIG. 4 depicts an exemplary Server Diary according to an embodiment of the present disclosure;

FIG. 5 depicts an exemplary Slide Viewer according to an embodiment of the present disclosure;

FIG. 6 depicts an exemplary search result that was obtained using the Slide Viewer of FIG. 5;

FIG. 7 depicts an exemplary balloon like sticky note according to an embodiment of the present disclosure; and

FIG. 8 depicts an exemplary portlet like sticky note according to another embodiment of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The present disclosure may take the form of an entirely hardware embodiment, an entirely software embodiment or an embodiment containing both hardware and software elements. In a preferred embodiment, the disclosure is implemented in software, which includes but is not limited to firmware, resident software, microcode, and so on

Embodiments of the present disclosure may include apparatuses for performing the operations described herein This apparatus may be specially constructed for the desired purposes, or it may comprise a general purpose computer selectively activated or reconfigured by a computer program stored in the computer

Furthermore, the disclosure may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code in order to reduce the number of times code has to be retrieved from bulk storage during execution Input/output or I/O devices (including but not limited to keyboards, displays, pointing devices, and so on) can be coupled to the system either directly or through intervening I/O controllers

Network adapters may also be coupled to the system to enable the data processing system to become coupled to other data processing systems or remote printers or storage devices through intervening private or public networks. Modems, cable modem and Ethernet cards are just a few of the currently available types of network adapters.

The processes and displays presented herein are not inherently related to any particular computer or other apparatus. Various general purpose systems may be used with programs in accordance with the teachings herein, or it may prove convenient to construct a more specialized apparatus to perform the desired method The desired structure for a variety of these systems will appear from the description below In addition, embodiments of the present disclosure are not described with reference to any particular programming language. It will be appreciated that a variety of programming languages may be used to implement the teachings of the disclosures as described herein

As part of the present disclosure an agent method and system are provided for facilitating the identification of the location, or whereabouts, of a client in a computer system. According to an embodiment of the present disclosure the location of a client/user in a computer system may be identified by recording and using recorded window identifiers that were uniquely assigned to application windows and screenshots of GUI (and other kinds of) windows associated with application windows visited by the client/user.

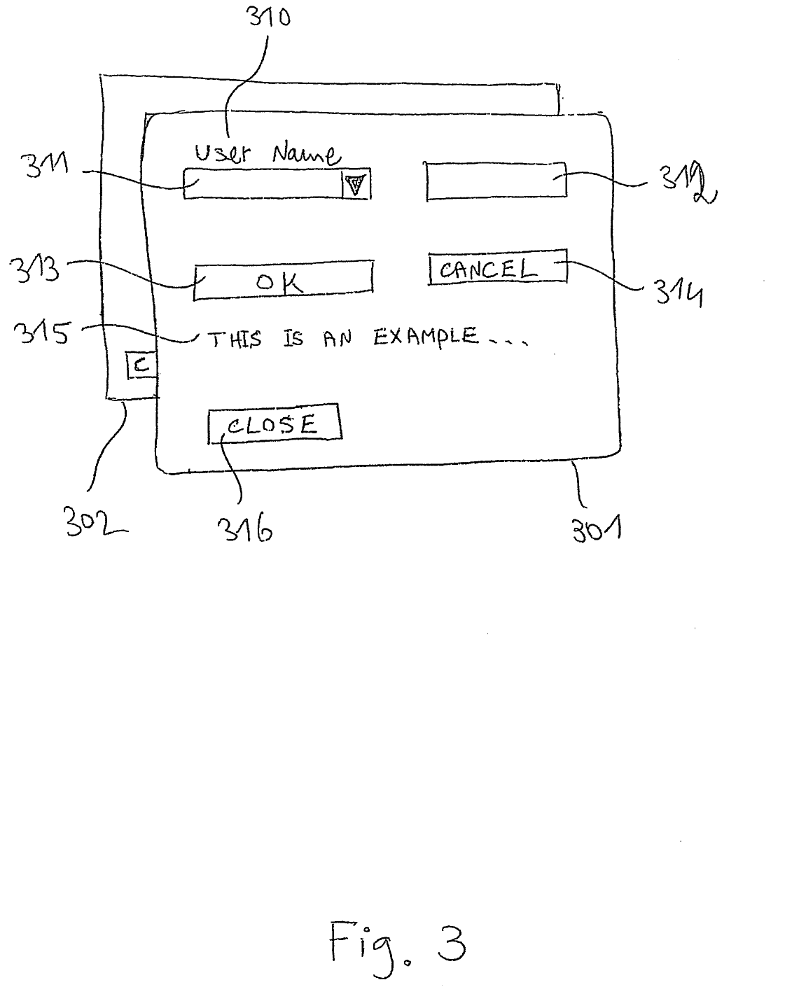

According to some embodiments each time an application window gets opened (usually by a user/client) for display (the application window is visited by the user/client), a monitoring agent (or some other entity, for example a processor or central server) may identify the opened/displayed/visited application window (whether it is a GUI screen or a different type of screen) and assign to the application window a unique window identifier Assigning a ‘unique window identifiers’ to an application window generally means that every time a given application window is opened for display (it is visited by users)), the monitoring agent (or the other entity) may generate and assign to the given application window the same window identifier It may occur that the same application window is open (runs) on multiple computer monitors or on other output devices (not necessarily at the same time), in which case the monitoring agent or other entity may individually identify each open application window and generate and assign to each one of the multiple application windows essentially the same window identifier The monitoring agent or other entity may store in the storage array a screenshot of each opened (visited) application window with an associated window identifier, in order to facilitate retrieval of application widow(s) (by using stored window identifier(s)). According to some embodiments the unique window identifier may be obtained by hashing related window/portlet elements of the application window by use of a hash function. The bash value may then be used as a window identifier. Obtaining a unique window identifier is more tally described in connection with FIG. 3

According to some embodiments once an application window is opened and an identifier is assigned to the open application window, the monitoring agent, processor or computer (or other monitoring entity) may record (store in the storage array) computer-wise activities related to the open application window. The computer-wise activities may be recorded in the storage array responsive to a client's trigger. The trigger may be essentially any kind of user-application interaction, for example, movement(s) of the computer's mouse, checking or unchecking a checkbox, and so on. The controller may record computer-wise activities by storing in the storage array a screenshot of the application window after each user-application interaction.

According to some embodiments, whenever required or desired (such as when there is a need to track computer-wise activities of client(s)), recorded window identifiers may be utilized for retrieving or fetching screenshots from the storage array, whether on individual basis and/or in a stream-wise manner, for example as a video clip

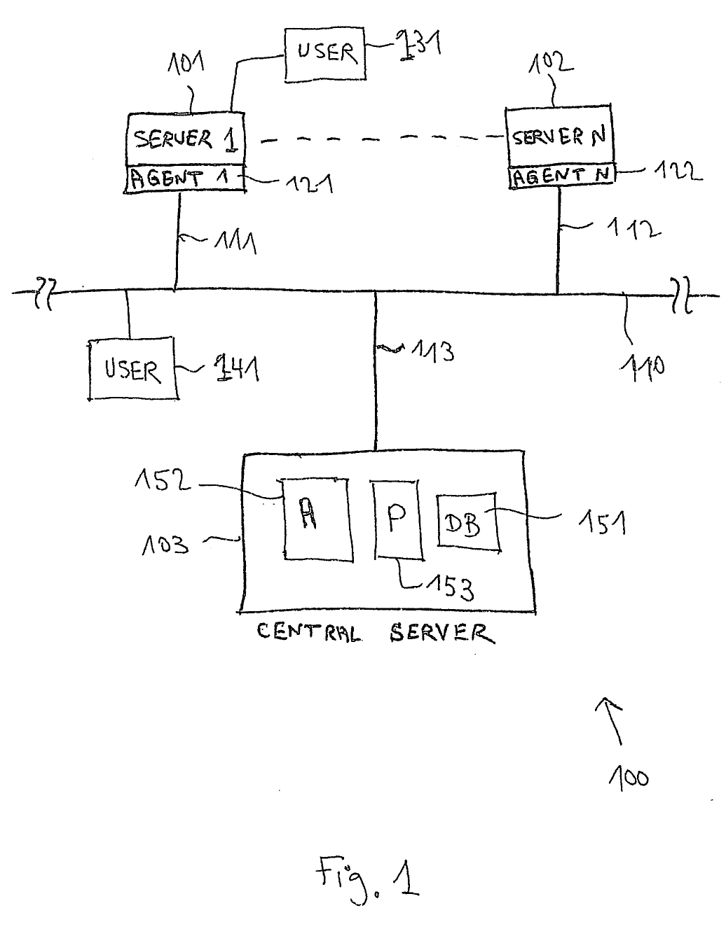

Referring now to FIG. 1, it schematically illustrates an exemplary system (generally shown at 100) for user-application interaction recording according to an embodiment of the present disclosure. Exemplary system 100 is shown consisting of N servers, designated SERVER 1 (shown at 101) to SERVER N (shown at 102), and a central server (CENTRAL SERVER, shown at 103) It is noted that, in connection with the present disclosure, ‘SERVER’ also refers to A ‘computer’, and ‘CENTRAL SERVER’ also refers to A ‘central computer’ That is, a computer may be utilized, which may, or may not, unction as a server. SERVER 1 (shown at 101) to SERVER N (shown at 102) may each be connected to computer network 110. For example, SERVERS 101 and 102 are shown connected to computer network 110 through network connections 111 and 112, respectively. CENTRAL SERVER 103 is shown connected to computer network 110 through network connection 113

According to the present disclosure any number of the N servers 101 to 102 may be equipped with a user/application monitoring agent For example, SERVER 101 and SERVER 102 are shown including user/application monitoring agents 121 and 122, respectively. The user/application monitoring agent (for example user/application monitoring agents 121 and 122) may be adapted to intercept, on the fly, individual application windows visited by a user and to generate and store, for each intercepted application window, a unique window identifier and an associated screenshot that includes an image of the visited application window The user/application monitoring agent may be further adapted to intercept the location of a user in the application, by generating a unique window identifier for the application window the user is currently visiting, and comparing the currently generated unique window identifier against already stored unique window identifier(s) After the user/application monitoring agent identifies the user's current location, the user/application monitoring agent may display to a user visual information, such as by presenting to the user screenshots slides or video clip(s), based on the user's identified current location The user/application monitoring agent may also (as an option) be adapted to intercept and store user activity steps relating to given application(s) that currently run(s) on the computer (for example, a server) which is monitored by the associated user/application monitoring agent By ‘activity steps’ is meant herein any user-application interaction, for example activation of the application, checking and unchecking actions or option box(es), clicking a computer's mouse, moving item(s) or object(s) from a first point/area to a second point/area on a computer's display, typing and deleting character(s), depressing a key on a keyboard, performing copy and paste operations, and so on

The user/application monitoring agent may be further adapted to associate with one or more of the intercepted user's activity steps a status parameter(s) of the given application The status parameter may be a single parameter or any number or combination of a variety of parameters For example, a parameter may indicate whether the application was accessed locally or remotely (for example through a terminal client, PcAnywhere, VNC or NetOP), who is/was connected to the server, the time and date of the connection, the activities of each connected user(s) is/are doing and from where the user(s) established the connection to the server. A user/application monitoring agent may intercept, on the fly, activity steps of local user(s) such as USER 131, and/or remote user(s) such as USER 141, which is connected to SERVER 101 through computer network 110

Each user/application monitoring agent may forward to CENTRAL. SERVER 103, over computer network 110, data representing, and/or relating to, the intercepted application window (for example the unique window identifies associated with the intercepted application window), and/or user activity steps with status parameter(s) associated with one or more of the intercepted user activity steps, herein referred to collectively as “user activity data” Each user/application monitoring agent may include a local storage array (not shown) for storing therein unique windows identifiers and/or screenshots related to unique windows identifiers and/or user activity data Alternatively, a portion of the local storage array may be allocated by the server hosting the user/application monitoring agent, and unique windows identifiers and/or screenshots related to unique windows identifiers and/or user activity data may be distributed between the user/application monitoring agent and the server hosting the agent SERVER 101, for example, is shown hosting user/application monitoring agent 121

User/application monitoring agents 121 and 112, for example, may independently forward to CENTRAL SERVER 103, over computer network 10, data related to intercepted application window(s) or portlet(s) visited by a user (for example windows identifiers and related screenshots) and/or user activity data as soon as a user visits an application window and/or a user activity step is intercepted by the respective user/application monitoring agent. Alternatively, user/application monitoring agent(s) may forward to CENTRAL SERVER 103, over computer network 110, data related to the intercepted application window(s) or portlet(s) and/or user activity data after a predefined delay after a user activity step is intercepted by the respective user/application monitoring agent Alternatively, user/application monitoring agent(s) may forward to CENTRAL SERVER 103, over computer network 110, user activity data responsive to a request signal generated by, and forwarded from, CENTRAL SERVER 103 to user/application monitoring agent(s). CENTRAL SERVER 103 may include a database (shown at 151) for storing user activity data The user activity data may include data representative of video (for example screenshots) and/or text (for example a comment that explains what bad happened and offers correction measures) that are associated with, or relevant for the, intercepted user activity step(s).

According to some embodiments CENTRAL SERVER 103 may also include an assigning module (‘A’, shown at 152) for generating and assigning a unique window identifier per application window that is intercepted and forwarded to CENTRAL SERVER 103 by the respective user/application monitoring agent CENTRAL. SERVER 103 may also store in database 151 windows identifiers and association data that associate each window identifier to the respective application window, for facilitating the playing of application windows; that is, if so requested by a client or by the system's manager or administrator. CENTRAL SERVER 103 may also store in database 151 the client (for example USERS 131 and/or 141) associated with each window identifier CENTRAL SERVER 103 may also include a playing module (‘P’, shown at 153) for playing, upon demand, recorded screenshots by utilizing the windows identifiers and association data stored in database 151. In one embodiment user/application monitoring agent(s) may send to CENTRAL SERVER 103 data representative of an intercepted application window and CENTRAL SERVER 103 may use that data to generate (such as by employing assigning module 152) a corresponding window identifier Alternatively, user/application monitoring agent(s) may generate windows identifiers and send them to CENTRAL SERVER 103.

According to the present disclosure a user/application monitoring agent functions like a motion detector in the sense that a user/application monitoring agent captures and documents substantially only application windows visited by a user, and, thereafter, the user activity on a computer and events that are directly related to the captured user activity. This implies that if a user is inactive (for example because s/he temporarily left his PC or s/he is drinking a coffee elsewhere), the associated user/application monitoring agent may enter an idle mode of operation, in which mode no storage of user active data occurs, which significantly reduces (compared to conventional methods) the amount of stored data and, therefore, the size of the storage array in AGENTS 121 and 122, and also the size of database 151.

According to the present disclosure each one of monitoring agents 121 to 122 and/or the central server 103 may include a “Server Diary” (not shown), which is a collection of all activities and communication sessions performed by user(s)/client(s) who accessed (locally or remotely) the related server A session may include video stream(s), which may represent at least a portion of the session, which may be (later, upon request) displayed (played, such as by player 153, to a viewer as slides (by using a Slide Viewer), and also a breakdown of all graphical user interfaces (GUIs) the client(s) has/have accessed or used in the session.

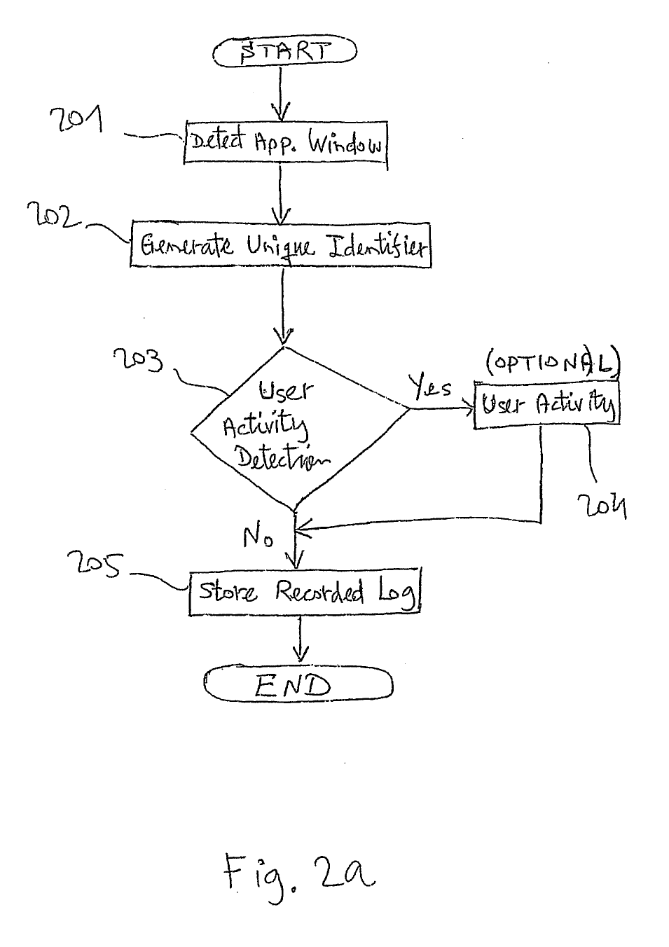

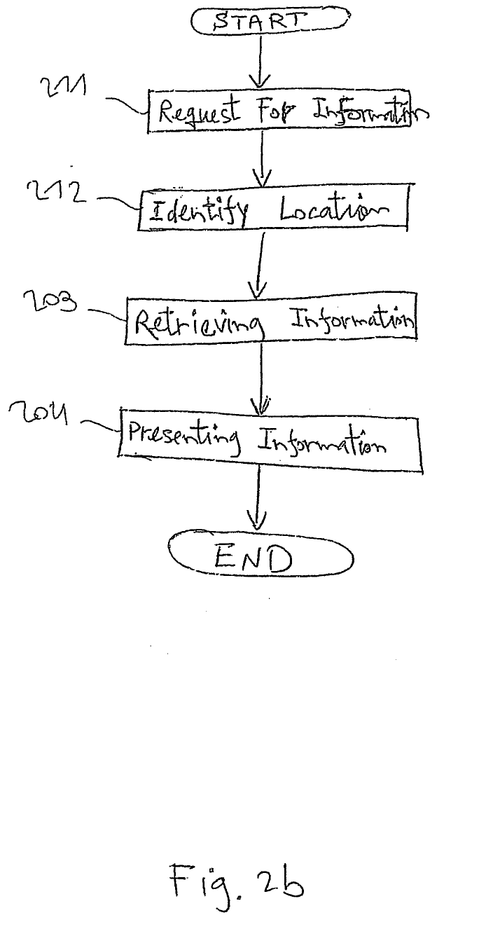

Referring now to FIG. 2a, an exemplary high-level flowchart for recording unique window identifiers for application window(s) visited by user(s) is shown and described according to some embodiments of the present disclosure. At step 201, a user/application monitoring agent (such as user/application monitoring agent 121 of FIG. 1) may check whether an application window is currently visited by a client (such as USER 131 of FIG. 1). If an application window is currently visited by a client, the currently visited application window may be identified by the user/application monitoring agent and, at step 202, a unique window identifier may be generated either by the user/application monitoring agent or by a central server such as CENTRAL SERVER 101 (as is explained earlier). If it is required to record also user activities associated with the detected application window (shown as ‘Yes’ at 203), such user activities may be detected at step 204. At step 205 the unique window identifier generated by the monitoring agent, or by the central server, may be recorded, with the user's activities detected at step 204, in a storage array such as DATABASE 151 of FIG. 1. A client (for example USER 141 of FIG. 1), which may be connected, for example to SERVER 101 of FIG. 1 through computer network 110, may instruct SERVER 101 to run a given application, for example, a Microsoft WORD application Using a Microsoft WORD application typically involves user activity steps such as selecting characters ‘Font’, ‘Font Size’, ‘Style’, ‘Bold’, ‘Italic’, performing ‘AutoText’, and so on. Substantially each user/application interaction is considered a user activity step. For example, setting (by the user) the font to “Times New Roman” (for example) is considered a user activity step that may be recorded by the user/application monitoring agent hosted by the server(s) running the Microsoft WORD application (in this example) If the user changes the value of the default font size to a new value (say from 12 to 16), another corresponding user activity step may be recorded by the user/application monitoring agent, which results from, and represents, the change in the font size

If, however, If it is not required to record also user activities associated with the detected application window (shown as ‘No’ at 203), then only the unique window identifier generated by the monitoring agent (or by the central server) may be recorded, such as in the storage array.

Referring now to FIG. 2b, an exemplary general high-level flowchart for retrieving information by user(s) based the user(s) location within an application is shown and described according to some embodiments of the present disclosure. It is assumed that a user is currently visiting an application window (hereinafter called the ‘active window’), and s/he requires information relating to the active window being visited. It is also assumed that the application window being visited by the user was visited at least once in the past by other user(s), and the previous visits have been recorded.

In order for the user to obtain the information, the user submits, at step 211, a request for the information The user may submit the request, for example, by depressing a dedicated key on the keyboard or by clicking his mouse in a certain area of the visited active window. Responsive to the request submitted by the user, the monitoring agent, or the central server, may first, at step 212, identify the location of the user by repeating steps 201 and 202 of FIG. 2a (detecting the active window the user is currently visiting and generating a unique window identifier for the detected active window). Then, the window identifier generated for the active window may be compared against recorded window identifier(s) to identify the user's relative location within the application session with which the user is engaged.

Then, at step 203 the monitoring agent may retrieve, through the central server, (location-based) information relevant to the current user's relative location within the application's session. The information may include, for example, metadata elating to screenshot(s) of application window(s) associated with the active window. Then, the agent may introduce the information to the user, for example as a stream of screenshots of the relevant application windows.

Referring now to FIG. 3, two exemplary application windows/portlets are shown and described for demonstrating how a unique window identifier may be generated for an application window according to an embodiment of the present disclosure. A first application window (shown at 301) is shown on top of a second application window (shown at 302). As was explained earlier, if a window such as window 301 is the foreground window, it is considered, in many cases, the active window. Accordingly, a monitoring agent (such as monitoring agent 121 of FIG. 1) or a computer, such as a central server (such as CENTRAL SERVER 103 of FIG. 1) may generate a unique window identifier for window 301.

According to the present disclosure the unique window identifier associated with (generated for) window/portlet 301 may be generated by employing a hash function on elements of the window elements. The elements of the exemplary window/portlet 301 include (in orderly manner) the label “User Name” (shown at 310), drop-down list 311, text box 312, button “OK.” (shown at 313), button “CANCEL” (shown at 314), label “THIS IS AN EXAMPLE, . . . ,” (shown at 315) and button “CLOSE” (shown at 316) Since each one of the exemplary elements window elements 310 through 316 (inclusive) is generated as part of the application by using corresponding definitions, these definitions may be utilized in the hashing process and the resulting hash value may uniquely characterize application window 301 which is, according to this example, the foreground window Alternatively, window elements such as window elements 310 through 316 may each be found or obtained by scanning the involved window Every time a user opens a window that is essentially identical to window 301, the same hash value will ensue if the same scanning scheme is employed. If application window/portlet 302 is rendered active (such as by clicking on it with a computer mouse), instead of window/portlet 301, the monitoring agent or central server will detect that window/portlet 302 has now become active and generate a unique window identifier for window/portlet 302. Likewise, navigating (by a user) between application windows/portlets will result in the regeneration of corresponding window identifiers which depend on elements of each window/portlet

Turning again to the exemplary elements 310 through 316 of exemplary application window 301, the hash function may be applied to the combination of “myprocess”+label 310+drop-down list 311+text box 312+button “OK” 313+button “CANCEL” 314+label “THIS IS AN EXAMPLE, . . . ,” 315+button “CLOSE” 316. Window element(s) may be identified (for example by a monitoring agent) regardless of the text they may contain For example, if a given window includes element(s) of a text box kind, the box(es) itself/themselves will be identified as ‘text box(es)’ but the actual text they may contain will be ignored by (will be left out of the) the hashing process. “myprocess” is an application identifier representing the application being currently used. Any other identifiers of an application may be used as well, for example, global unique identifiers, titles, and so on Hashing also an application identifier is useful because, at least theoretically, different applications may utilize identical or similar windows/portlets, for which reason there is a need to make a distinction between similar windows/portlets which are used by different applications. Such a distinction may be facilitated, for example by including application identifier(s) in the hashing process.

According to the present disclosure a “Server Diary” is associated with each of servers SERVER 101 through SERVER 102 (of FIG. 1) Each Server Diary may maintain a collection of all activity sessions that had been preformed by users who accessed the monitored server (regardless of local or remote access) with which the Server Diary is associated In general, each activity session may include a video data that can be played to (viewed by) a user and/or a list of all graphical user interface (GUI) screenshots relating to screens accessed by the user, which may be browsed using a Slide Viewer

### The Server Diary

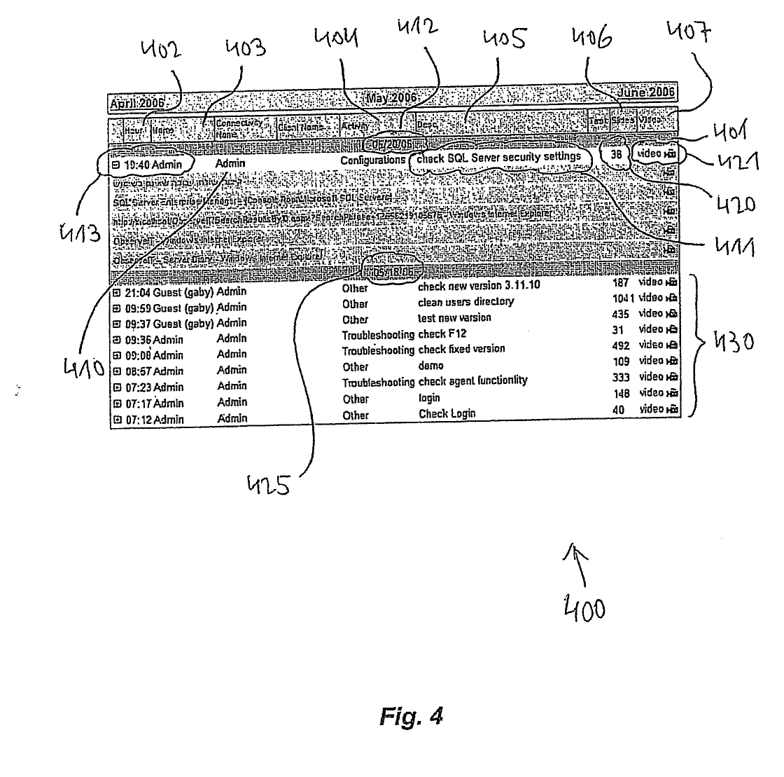

Referring now FIG. 4, a general screen (generally shown at 400) is depicted, which shows an exemplary server diary The exemplary server diary may have fields such as a date line (shown at 401), time (‘Hour’, shown at 402), name of the user/client (‘Name’, shown at 403), activity (‘Activity’, shown at 404), description (‘Desc’, shown at 405), number of recorded slides (‘Sliders’, shown at 406) and video (‘Video’, shown at 407)

Looking into the exemplary server diary of the SQL Server shows that the system administrator (‘Admin’, shown at 410) checked the SQL Server security settings (shown at 411) on May 20, 2006 (shown at 412) at 19:40 (shown at 413) Thirty-eight screenshots (shown at 420) were recorded and a video file (shown at 421) was generated, which are associated with the checking of the SQL server security settings (shown at 411) The lower part (shown at 430) of the server diary includes a summarizing list of various users' activity steps that were recorded on May 18, 2006 (shown at 425) in a database of a central server, for example in database 151 of CENTRAL SERVER 103.

### Slide Viewer

A Slide Viewer may allow a viewer (usually the system administrator) to select for displaying slide(s) of screenshots associated with a given user-server session (user-application interaction). Regarding the referenced example, when a given series of slides is selected (such as by being clicked by the viewer), change(s) made, for example by the administrator on the SQL Server may be displayed to the viewer.

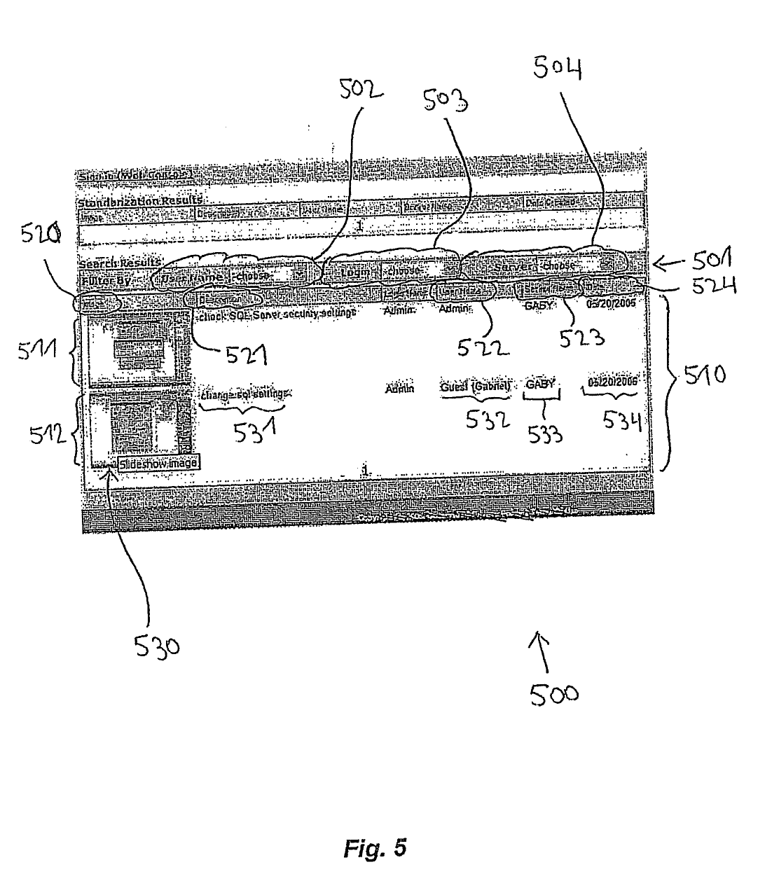

Referring now to FIG. 5, an exemplary Slide Viewer is shown (at 500) and described Since there may be recorded in database 151 of CENTRAL SERVER 103 (for example) many screenshots, which may be associated with different users interacting with different servers, a viewer may need a search engine to find slides which he thinks may be relevant Slide Viewer 500, therefore, includes, or utilizes a search engine that will enable a viewer to search for slides (for example) by using a search filter (shown at 501) Exemplary search filter 501 is shown including the following filter fields: ‘User Name’ (shown at 502), login name (‘Login’, shown at 503) and server name (‘Server’, shown at 504).

To activate the search engine, or a search function, the user typically has to point (for example with a computer mouse) at an application window/screen for which search is sought and depress a dedicated functional button or key (for example a key on a keyboard designated “F12”), to trigger, or commence, a corresponding search process Responsive to the depressing of such a functional button or key, the central server (for example) may locate the user's current location and provide him/her with previously recorded information and/or video stream and/or screenshots slides relevant to, associated with, based on or derived from the same unique window identifier of the application window/screen for which the user has initiated the search process.

An exemplary search result is shown in part 510 of Slide Viewer 500 The exemplary search result includes a thumbnail like list that includes, in this example, only two items, or search results designated 511 and 512 (of course there may be more than two), which have essentially the same unique window identifier. The search results, all of which have essentially the same unique window identifier, may be related to different user activity steps, different sessions and/or different users Each item of the search result may include an image of a related screenshot (‘Image’, shown at 520), brief description of the activity category (‘Description’, shown at 521), name of the user (‘User Name’, shown at 522) that performed the activity step, name of server (‘Server Name’, shown at 523) for which user activity step(s) were recorded in CENTRAL SERVER 103 (for example), and date on which the user activity step was recorded. For example, search result 512 displays a slideshow image (shown at 530) representative of the screenshot involved in the related user activity step. According to search result 512, a user called ‘Guest (Gabriel)’ (shown at 532) changed SQL settings (“change sql settings”, shown at 531) on a server called ‘GABY’ (shown at 533), on May 20, 2006 (shown at 534). In order for the viewer to see what SQL setting(s) has/have been changed on SQL server GABY, the viewer may select image for inspection, such as by double clicking on image 530. It is noted that the Slide Viewer may display to a user not only data, information or screenshots recorded/stored in sessions in which the user is/was directly involved, but also data, information or screenshots recorded/stored in sessions in which other user(s) are/were involved.

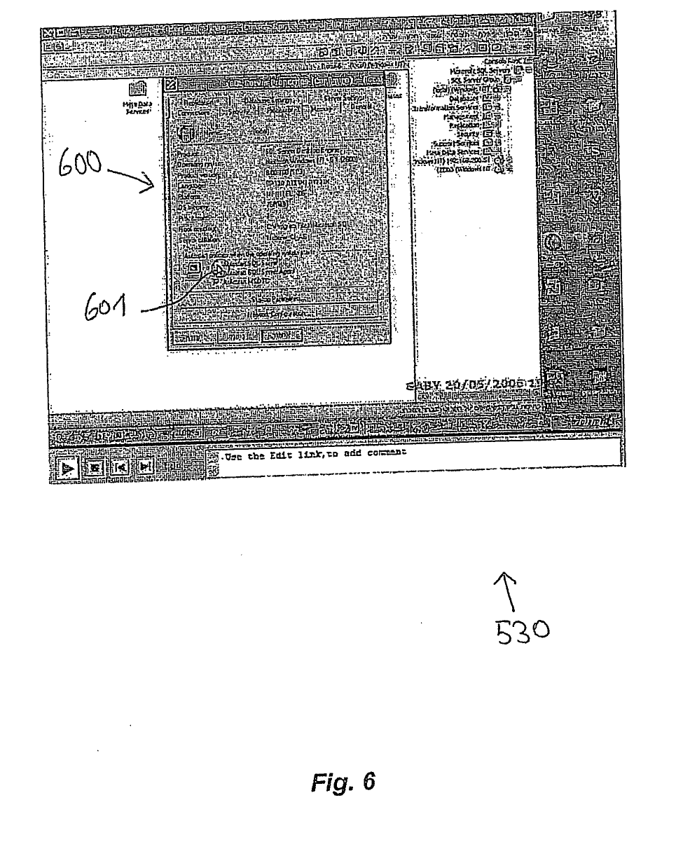

Referring now to FIG. 6, the selection of the exemplary slideshow image 530 of FIG. 5 is demonstrated Exemplary slideshow image 530 is shown including the portlet (generally shown at 600) in which setting(s) were changed by the user Guest (Gabriel) (shown at 532 in FIG. 5) As is evident from portlet 600, the user Guest (Gabriel) unchecked a box called ‘Autostart SQL Server’ (shown at 601), which is why the SQL server did not run its tasks. In order to prevent other users from doing the same error (for example unchecking the ‘Autostart SQL Server’ box, shown at 601), the viewer may annotate the potentially problematic application window by attaching, adding or, otherwise associating, a ‘sticky note’ to a potentially problematic application window ‘Potentially problematic application window’ generally refers to an application window (portlet 600 in this example) already mishandled or misused by at least one user, for which reason it is worthwhile warning other users from doing the same errors.

According to the present disclosure, sticking a note to a potentially problematic application window (annotating may be implemented by depressing a predetermined functional key, say ‘F11’, while viewing the potentially problematic application window, whereby to cause a ‘comment/guiding/hazard window’ (may also be referred to as a “guiding note” or a “sticky note”) to pop-up next to (adjacent) the potentially problematic application window, or in a partially overlapping manner. Then, the viewer may freely enter a comment in the comment/guiding/hazard window. From now on, every time a user activity step will involve (result in) displaying to a user a potentially problematic application window, regardless to the server/computer which the application window was activated (for example a portlet similar to portlet 600), the central server (for example CENTRAL SERVER 103) will attach to the potentially problematic application window, in the form of a comment/guiding/hazard window, a corresponding, or relevant, guiding or hazard ‘sticky note’

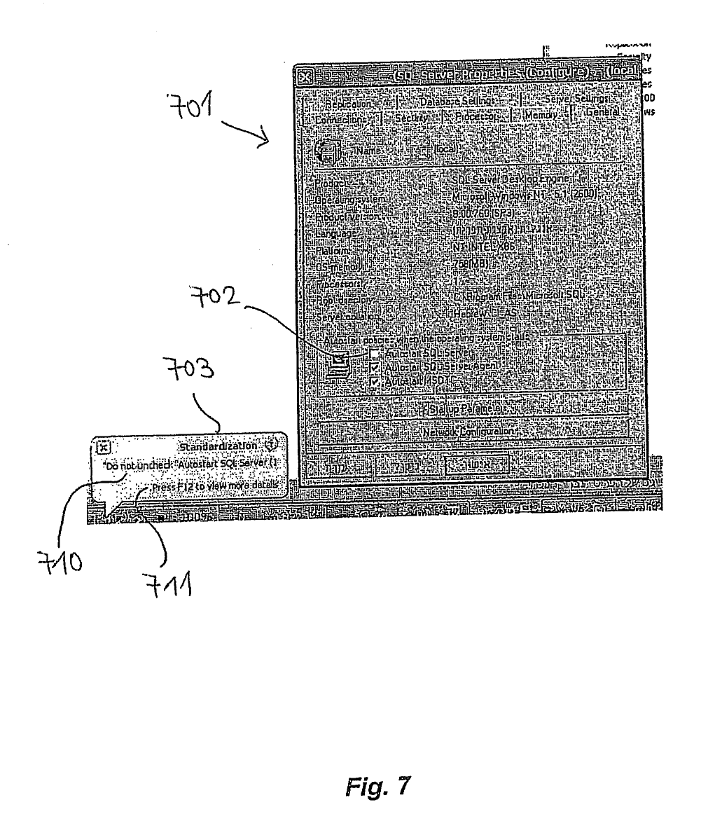

Referring now to FIG. 7, an exemplary ‘balloon’ like sticky note is shown and described according to an embodiment of the present disclosure. It is assumed that an ‘Autostart SQL Server’ box was unchecked, at least once, by a user of the SQL server, as exemplified in connection with portlet 600 of FIG. 6, where the Autostart SQL Server box (shown at 601) is shown unchecked.

Potentially problematic application window 701 (in this example a portlet) is shown with Autostart SQL Server box (shown at 702) unchecked, due to a user recently unchecking it According to one embodiment balloon-like comment/guiding/hazard window 703 may pop-up next to (adjacent) potentially problematic application window 701 responsive to the unchecking of Autostart SQL Server' box 702. According to this example, the user unchecking Autostart SQL Server' box 702 may be warned by comment/guiding/hazard window 703 not to uncheck box 702 (“Do not uncheck Autostart SQL Server” (shown at 710). If the user desires to get some more information regarding the specific forbidden action (unchecking box 702), he may do so, for example, by depressing a functional key on his keyboard, say ‘F12’ (shown at 711)

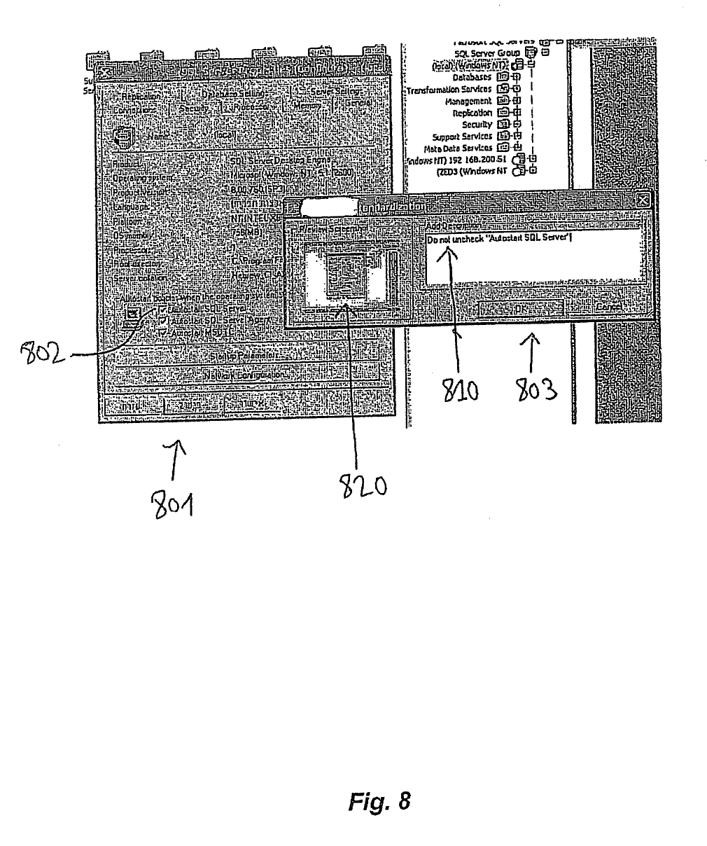

Referring now to FIG. 8, an exemplary ‘portlet’ like sticky note is shown and described according to another embodiment of the present disclosure. Potentially problematic application window 801 (in this example a portlet) is shown with Autostart SQL Server box (shown at 802) checked According to this example, displaying potentially problematic application window 801 causes portlet-like comment/guiding/hazard window 803 to pop-up to warm the user not to uncheck box 802 (“Do not uncheck Autostart SQL Server” (shown at 810). A Preview Screenshot (shown at 820) may be displayed to the user as part of comment/guiding/hazard window 803.

Comment/guiding/hazard windows, such as comment/guiding/hazard window 703 (in FIG. 7) and 803 (in FIG. 8), enables viewers and users to pass to, share with, or inform other users and viewers (of) their user-application(s) experience User(s) may also warn or deter other user(s) from performing user activity steps that may slow down a running application, and so on.

The capabilities (recording user activity steps, retrieving screenshots on demand, using sticky notes to alert/guide others, and so on) disclosed in the present disclosure may be utilized for additional features than the features described so far. For example, they can be used as part of a ‘Help’ function For example, a user may not be sure how to correctly configure the SQL server' security property page In such a case, the user may depress a functional key, for example ‘F12’, while he views the SQL server' security property page, to view all previous video sessions done by the organization's administrator on all the servers. Then, the user may simply follow the administrator's series of actions, both before and after the current user's activity step, whereby to guide the user as to the next step(s) (user activity step) s/he should take.

By using video capabilities, successive screenshots relevant to the situation at hand (the situation for which the user seeks help) may be automatically displayed to the user, one screenshot after another, for example as a video stream displaying to the user preferred, correct, recommended or commonly known, step or series of steps to be taken by the user at this stage. According to the present disclosure a user may get help-like information no matter which application window or portlet s/he is currently visiting To activate the help function the user typically has to point (for example with a computer mouse) at the item (field, box, form or screen) for which help is sought, and depress a dedicated functional button or key (for example a key on a keyboard designated “F12”) to trigger, or commence, a corresponding search process Responsive to the depressing of such a button or key, the central server (for example) may locate the user's current location and provide him/her with information and/or video stream and/or screenshots slides relevant to, associated with, based on or derived from, the user's current location, which were previously recorded The previously recorded information and/or video stream and/or screenshots slides may be information, video stream and/or screenshots slides previously visited by either the user seeking the help, or by other user(s)

The system and method disclosed herein may facilitate auditing organization's IT-related activities, organization's know-how preservation, visual guidance and troubleshooting, working procedure recommendation(s) and enforcement, monitoring user(s) activity, security tightening, training and help support.

While certain features of the disclosure have been illustrated and described herein, many modifications, substitutions, changes, and equivalents will now occur to those skilled in the art. It is, therefore, to be understood that the appended claims are intended to cover all such modifications and changes as fall within the true spirit of the disclosure

What is claimed is:

1. A user/application monitoring agent adapted to characterize an application window running on a computer and generate a unique window identifier for said application window based on one or more structural elements of said application window.

2. The user/application monitoring agent according to claim 1, wherein said agent identifies structural elements of the application window by scanning said application window

3. The user/application monitoring agent according to claim 1, wherein the characterized application window is the foreground window on a display screen

4. The user/application monitoring agent according to claim 1, wherein structural elements comprise: label(s), drop-down list(s), drop-down menu(s), text(s), option box(es), checkbox(es), combo box(es), list box(es), image(s) and button(s)

5. The user/application monitoring agent according to claim 1, wherein the unique window identifier is a bash value obtained by hashing data representing structural elements

6. The user/application monitoring agent according to claim 1, wherein said user/application monitoring agent is further adapted to cause the unique window identifier to be stored with an associated screenshot representing said application window

7. The user/application monitoring agent according to claim 1, wherein said agent comprises a search engine adapted to search and play screenshots based on an input from said user.

8. The user/application monitoring agent according to claim 7, wherein the search engine displays a list of essentially all video clips which comprises screenshot(s) associated with application(s) window(s) whose unique window identifier(s) is/are essentially identical to the unique window identifier of the application window being currently visited.

9. The user/application monitoring agent according to claim 1, wherein said user/application monitoring agent resides within the computer.

10. The user/application monitoring agent according to claim 6, wherein the unique window identifier is stored associated with data associated with a user visiting the application window.

11. The user/application monitoring agent according to claim 5, wherein the unique window identifier and associated screenshot(s) are stored in a remote central server

12. The user/application monitoring agent according to claim 11, wherein said user/application monitoring agent is further adapted to generate and forward to the central server user activity data associated with intercepted activity steps relating to visited application window(s)

13. The user/application monitoring agent according to claim 12, wherein said user/application monitoring agent is further adapted to annotate aspects of user(s) activity data and to cause annotations to be stored in a server diary associated with the computer.

14. The user/application monitoring agent according to claim 1, wherein said user/application monitoring agent utilizes unique window identifier(s) in visual audit trail, troubleshooting, guidance, help or assistance associated with a running application.

15. The user/application monitoring agent according to claim 14, wherein said user/application monitoring agent is further adapted to render to a user visual audit trail, troubleshooting, guidance, help or assistance based on the current user's location.

16. The user/application monitoring agent according to claim 14, wherein said user/application monitoring agent is further adapted to facilitate displaying of a hazard notification if an irregular user activity pattern is detected.

17. The user/application monitoring agent according to claim 16, wherein said user/application monitoring agent visually attaches to a foreground application window a guiding note associated with said application window or with the application involved

18. The user/application monitoring agent according to claim 17, wherein a guiding note passes information to, or share best practice(s) with, user(s), or deter user(s) from selecting specific options in the application window

19. The user/application monitoring agent according to claim 4, wherein said user/application monitoring agent is further adapted to play recorded screenshots, on a user's demand, as video clip(s) or screenshots slides, by using window identifiers to respectively retrieve stored screenshots.

20. A method for recording user/application interaction, comprises:
intercepting, by a user/application monitoring agent, an application window running on a computer; and
generating a unique window identifier for said application window based on one or more structural elements of said application window

21. The method according to claim 20, wherein generating comprises scanning of structural elements of the application window.

22. The method according to claim 20, wherein the characterized application window is the foreground window on a display screen.

23. The method according to claim 20, wherein structural elements comprise: label(s), drop-down list(s), drop-down menu(s), text(s), option box(es), checkbox(es), combo box(es), list box(es), image(s) and button(s).

24. The method according to claim 20, wherein the unique window identifier is a hash value obtained by hashing data representative of structural element(s).

25. The method according to claim 20, wherein a unique window identifier is stored with an associated screenshot representing the application window

26. The method according to claim 25, wherein the unique window identifier is stored associated with details of the user visiting the application window.

27. The method according to claim 25, wherein screenshot(s) is/are searched for and introduced to a user based on an input from said user.

28. The method according to claim 27, wherein, as a result of the search, a list of essentially all video clips is displayed, which comprises screenshot(s) associated with application(s) window(s) whose unique window identifier(s) is essentially identical to the unique window identifier of the application window being currently visited

29. The method according to claim 20, wherein unique window identifier(s) is/are utilized in visual audit trail, troubleshooting, guidance, help or assistance associated with a running application

30. The method according to claim 29, wherein visual audit trail, troubleshooting, guidance, help or assistance are rendered to a user based on the current user's location.

31. The method according to claim 29, wherein a hazard notification is displayed to a user if an irregular user activity pattern is detected

32. The method according to claim 31, wherein a guiding note is visually attached to an application window which is associated with said application window or with the application involved

33. The method according to claim 32 wherein a guiding note passes information to, or share best practice(s) with, user(s), or deter user(s) from selecting specific options in the application window.

34. The method according to claim 25, wherein screenshots are played, on a user's demand, as video clip(s) or screenshots slides, by using window identifiers to respectively retrieve stored screenshots.

35. A system for user-application interaction recording, comprising:
a user/application monitoring agent adapted to intercept application windows(s) running on a computer; and
a central server adapted to receive, from said user/application monitoring agent, data relating to an intercepted application window(s), and to store in a storage array said data associated with unique screen identifier(s)

36. The system according to claim 35, wherein the user/application monitoring agent resides within the computer running the application.

37. The system according to claim 35, wherein the user/application monitoring agent is further adapted to generate and forward to the central server user activity data associated with intercepted activity steps relating to visited application screen(s)

38. The system according to claim 35, wherein the unique screen identifier is generated and forwarded by the user/application monitoring agent to the central server

39. The system according to claim 35, wherein the unique screen identifier is generated by the central server based on data forwarded to said central server from the user/application monitoring agent.

40. The system according to claim 35, wherein the central server stores in the storage array set(s) of window identifiers or user activity data originating from a plurality of user/application monitoring agents, each of which being associated with a respective monitored computer.

41. The system according to claim 40, wherein the central server performs an audit process, on demand, by utilizing window identifier(s) or user(s') activity data.

42. The system according to claim 40, wherein the central server displays a hazard notification if an irregular user activity pattern is detected.
